(19) United States
(12) Patent Application Publication
(10) Pub. No.: US 2005/0207137 A1
(43) Pub. Date: Sep. 22, 2005

(54) Mounting structure for touch panel and touch panel with support plate

(76) Inventors: Kazuhiro Nishikawa, Kyoto (JP); Takeshi Asakura, Kyoto (JP)

Correspondence Address: WENDEROTH, LIND & PONACK, L.L.P., 2033 K STREET N. W., SUITE 800, WASHINGTON, DC, 20006-1021, US

(21) Appl. No.: 10/515,261

(22) PCT Filed: May 22, 2003
(86) PCT No.: PCT/JP03/06375

§ 371 Date: Nov. 22, 2004

(30) Foreign Application Priority Data
May 23, 2002 (JP) 2002-148530
Jun. 17, 2002 (JP) 2002-176380

(51) Int. Cl. F21V 9/16

(52) U.S. Cl. 362/84

(57) ABSTRACT

There is provided a mounting structure for a touch panel composed of a touch panel having a satin finished surface formed on at least either facing surface of an upper insulating substrate and a lower insulating substrate, the touch panel being mounted on a display, and being capable of suppressing glare on a display screen. The touch panel having the satin finished surface formed on at least either facing surface of the upper insulating substrate and the lower insulating substrate is entirely bonded to the display by a diffusion adhesive layer for mounting of the touch panel.

### TECHNICAL FIELD

The present invention relates to a mounting structure for a touch panel and a touch panel with a support plate, which is composed of a touch panel having a satin finished surface formed on at least either facing surface of an upper insulating substrate and a lower insulating substrate, the touch panel being mounted on a display, and being capable of suppressing glare on a display screen.

### BACKGROUND ART

Conventionally, a touch panel 101 is widely used (see FIG. 8) as input equipment which is mounted on the front surface of portable electronic equipment equipped with a display 103 such as cordless telephone sets, cell phone sets, calculators, subnotebook personal computers, PDAs (Personal Digital Assistants), digital cameras, video cameras, and business communication equipment as well as the front surface of the monitor of a personal computer, and whose surface is pressed by pens or fingers in accordance with instructions appeared through the display screen for allowing execution of various operations.

The touch panel 101 is composed of an upper electrode plate having an upper electrode 105 made of transparent conductive film formed on the lower surface of an upper insulating substrate 104 made of plastic film, and a lower electrode plate having a lower electrode 107 made of transparent conductive film formed on the upper surface of a lower insulating substrate 106 made of a glass plate or plastic film, the upper electrode plate and the lower electrode plate being disposed so as to face each other with an air layer interposed in between the electrodes. Examples of the structure for mounting the touch panel 101 on the display 103 include a structure in which a touch panel having a transparent adhesive layer 113 such as acrylic adhesive layer provided on its entire back surface is mounted on the front surface of the display 103 as disclosed in Japanese unexamined patent publication No. 61-131314.

In these days, emphasis is being given to development of products such as the aforementioned personal computers with smaller weight and width, and this requires development of the touch panel 101 itself with smaller weight and width as well as development of the mounting method which allows the touch panel 101 to have a smaller width, which usually results in adoption of the touch panel whose lower insulating substrate 106 is made of plastic film that allows manufacturing of thin film.

However, the plastic film, if used as the lower insulating substrate 106, causes an issue that Newton rings are generated when the display is viewed through the touch panel 101 as shown in FIG. 9. The generation mechanism of the Newton rings in the touch panel 101 is such that the upper insulating substrate 104 made of plastic film sags in the manufacturing process of the touch panel 101 and the like, so light reflected by the upper surface and the lower surface of the thin air layer disposed between the upper electrode and the lower electrode interferes, and so the interference fringes appear as contrasting concentric circles (reference numeral 90 in FIG. 9 denotes a light portion of the interference fringes, reference numeral 91 denotes a shade portion of the interference fringes, and reference numeral 92 denotes displayed characters). If the lower insulating substrate 106 is a glass plate with dimensional stability, then it is possible to apply treatment such as heating to the touch panel 101 so as to tauten the upper insulating substrate 104 made of plastic film for preventing generation of the Newton rings. However, in the case where the plastic film is used as the lower insulating substrate 106 as described above, the lower insulating substrate 106 is also poor in dimensional stability, and therefore it is difficult to tauten the upper insulating substrate 104 even with treatment such as heating being applied.

Accordingly, in order to prevent the Newton rings from being generated in the touch panel 101 having the lower insulating substrate 106 made of plastic film, there has been proposed a method in which at least either facing surface of the upper insulating substrate 104 and the lower insulating substrate 106 is satin finished, and this satin finished surface scatters reflected light so as to make the Newton rings unclear (see FIG. 10).

However, recent high-resolution displays (e.g., displays of 200 dpi or more) create such a new kind of issue that mounting a touch panel having the satin finished surface causes degradation of visibility such as glare (bleeding) on the display screen. It is to be noted that FIG. 11 is a view showing the glare in a schematic way so as to clarify that in contrast to a green background 95 in FIG. 11, a number of red dots 93 and blue dots 94 are viewed, and a number of these red dots 93 and blue dots 94 cause glare and bleeding on the characters 92.

Accordingly, an object of the present invention is to provide a mounting structure for a touch panel wherein the touch panel is mounted on a display, and the touch panel with a support plate which overcome the forgoing deficiencies, while using the touch panel having a satin finished surface formed on at least either facing surface of an upper insulating substrate and a lower insulating substrate, and which are able to suppress the glare on a display screen.

### DISCLOSURE OF INVENTION

In accomplishing the above object, the present invention is constituted as follows.

According to a first aspect of the present invention, there is provided a mounting structure for a touch panel, comprising a touch panel which is composed of an upper electrode plate having an upper electrode made of transparent conductive film formed on a lower surface of an upper insulating substrate made of plastic film, and a lower electrode plate having a lower electrode made of transparent conductive film formed on an upper surface of a lower insulating substrate made of plastic film, said upper electrode plate and said lower electrode plate being disposed so as to face each other with an air layer interposed in between said upper and lower electrodes, and which has a satin finished surface formed on at least either facing surface of said upper insulating substrate and said lower insulating substrate,
wherein by a diffusion bonding member for refracting and reflecting visible light from a display, said touch panel is bonded to said display for mounting of said touch panel thereto.

According to a second aspect of the present invention, there is provided the mounting structure for a touch panel as defined in the first aspect, wherein said diffusion bonding member is a diffusion adhesive layer for bonding said touch panel and said display entirely.

According to a third aspect of the present invention, there is provided the mounting structure for a touch panel as defined in the second aspect, wherein said diffusion bonding member is a transparent mounting sheet formed from said diffusion adhesive layer laid on one surface of a silicon rubber sheet, and
a front surface of said display is entirely bonded to said diffusion adhesive layer of said mounting sheet, and said touch panel is mounted on a front surface of said mounting sheet placed on said display so as to bring said silicon rubber sheet of said mounting sheet into contact with said touch panel.

According to a fourth aspect of the present invention, there is provided the mounting structure for a touch panel as defined in the second aspect, wherein
said diffusion bonding member is a transparent mounting sheet formed from said diffusion adhesive layer laid on one surface of a silicon rubber sheet,
a back surface of said touch panel is entirely bonded to said mounting sheet by said diffusion adhesive layer of said mounting sheet, and said touch panel with said mounting sheet provided is mounted on a front surface of said display so as to bring said silicon rubber sheet of said mounting sheet into contact with said display.

According to a fifth aspect of the present invention, there is provided the mounting structure for a touch panel as defined in any one of the second to fourth aspects, wherein haze of said diffusion adhesive layer is 10 to 50%, and surface haze of said satin finished surface of said touch panel is 1.5 to 5%.

According to a sixth aspect of the present invention, there is provided the mounting structure for a touch panel as defined in the first aspect, wherein said diffusion bonding member is composed of an adhesive layer disposed on a back surface of said lower insulating substrate and a support plate made of a plastic plate which are entirely bonded to a back surface of said lower insulating substrate by said adhesive layer, and either one of said support plate and said adhesive layer has a diffusion function to refract and reflect visible light from said display.

According to a seventh aspect of the present invention, there is provided the mounting structure for a touch panel as defined in the sixth aspect, wherein said adhesive layer has the diffusion function, haze of said adhesive layer is 5 to 45%, and surface haze of said satin finished surface of said touch panel is 1.5 to 5%.

According to an eighth aspect of the present invention, there is provided the mounting structure for a touch panel as defined in the sixth or seventh aspect, wherein said support plate has the diffusion function, haze of said support plate is 10 to 50%, and surface haze of said satin finished surface of said touch panel is 1.5 to 5%.

According to a ninth aspect of the present invention, there is provided the mounting structure for a touch panel as defined in the sixth or seventh aspect wherein the diffusion function is to refract and reflect visible light from said display with fillers which are dispersed as light diffusing agents.

According to a tenth aspect of the present invention, there is provided the mounting structure for a touch panel as defined in the eighth aspect, wherein the diffusion function is to refract and reflect visible light from said display with fillers which are dispersed as light diffusing agents.

According to an eleventh aspect of the present invention, there is provided the mounting structure for a touch panel as defined in the sixth or seventh aspect, wherein said diffusion bonding member is further composed of an adhesive layer for entirely bonding said touch panel and said display.

According to a 12th aspect of the present invention, there is provided the mounting structure for a touch panel as defined in the eighth aspect, wherein said diffusion bonding member is further composed of an adhesive layer for entirely bonding said touch panel and said display.

According to a 13th aspect of the present invention, there is provided a touch panel with a support plate for use in the mounting structure for a touch panel as defined in the sixth or seventh aspect.

According to a 14th aspect of the present invention, there is provided a touch panel with a support plate for use in the mounting structure for a touch panel as defined in the eighth aspect.

### BRIEF DESCRIPTION OF DRAWINGS

These and other objects and features of the present invention will become apparent from the following description taken in conjunction with preferred embodiments of the invention with reference to the accompanying drawings, in which:

FIG. 1 is a cross-sectional view showing a mounting structure for a touch panel according to a first embodiment of the present invention;

FIG. 2 is a schematic view explaining the optical operation in a mounting structure for a touch panel having a satin finished surface according to the prior art;

FIG. 3 is a schematic view explaining the optical operation in the mounting structure for a touch panel having a satin finished surface according to the first embodiment of the present invention;

FIG. 4 is a cross-sectional view showing a mounting structure for a touch panel according to a first modification of the first embodiment of the present invention;

FIG. 5 is a cross-sectional view showing a mounting structure for a touch panel according to a second modification of the first embodiment of the present invention;

FIG. 6 is a cross-sectional view showing a mounting structure for a touch panel according to a third modification of the first embodiment of the present invention;

FIG. 7 is a cross-sectional view showing a mounting structure for a touch panel according to a fourth modification of the first embodiment of the present invention;

FIG. 8 is a cross-sectional view showing a general mounting structure for a touch panel according to the prior art;

FIG. 9 is an explanatory view explaining, in a schematic way, the state in which Newton rings are generated;

FIG. 10 is a cross-sectional view showing one example of a touch panel having a satin finished surface;

FIG. 11 is an explanatory view explaining bleeding in a schematic way;

FIG. 12 is an explanatory view showing the state of high contrast with use of a display as a single unit;

FIG. 13 is an explanatory view showing the state in which even the display with high contrast as a single unit, if combined with a touch panel with surface haze of more than 5%, gains low contrast;

FIG. 14 is an explanatory view showing fillers subjected to primary aggregation and secondary aggregation;

FIG. 15 is explanatory view showing monodispersed fillers;

FIG. 16 is an explanatory view showing the case where a diffusion adhesive layer and a satin finished surface is distant from each other;

FIG. 17 is an explanatory view showing the case where the diffusion adhesive layer and the satin finished surface are less distant from each other than those in FIG. 16;

FIG. 18 is a cross-sectional view showing a touch panel with a support plate according to a second embodiment of the present invention;

FIG. 19 is a schematic view explaining the optical operation in a touch panel with a support plate according to the prior art;

FIG. 20 is a schematic view explaining the optical operation in the touch panel with a support plate according to the second embodiment of the present invention;

FIG. 21 is a cross-sectional view showing a touch panel with a support plate according to the prior art;

FIG. 22 is a cross-sectional view showing a touch panel with a support plate having a satin finished surface according to the prior art;

FIG. 23 is a cross-sectional view showing a touch panel with a support plate according to a third embodiment of the present invention;

FIG. 24 is a schematic view explaining the optical operation in the touch panel with a support plate according to the third embodiment of the present invention;

FIG. 25 is a cross-sectional view showing a touch panel with a support plate according to a fourth embodiment of the present invention;

FIG. 26 is a schematic view explaining the optical operation in the touch panel with a support plate according to the fourth embodiment of the present invention;

FIG. 27 is a view showing the principle of an apparatus for a measurement method A in a test in conformity with JIS K 7105 (1981); and

FIG. 28 is an explanatory view explaining the condition of an integrating sphere in the measurement method A.

### BEST MODE FOR CARRYING OUT THE INVENTION

Before the description of the present invention proceeds, it is to be noted that like parts are designated by like reference numerals throughout the accompanying drawings.

Detailed description is hereinbelow given of a first embodiment in the present invention with reference to the drawings.

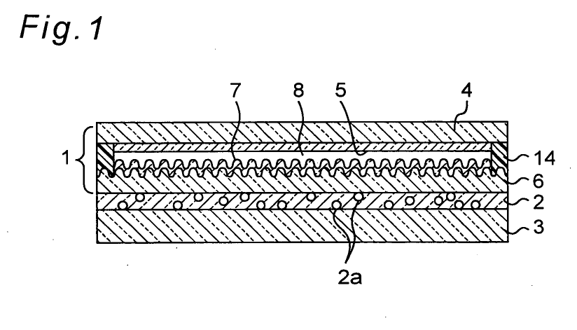

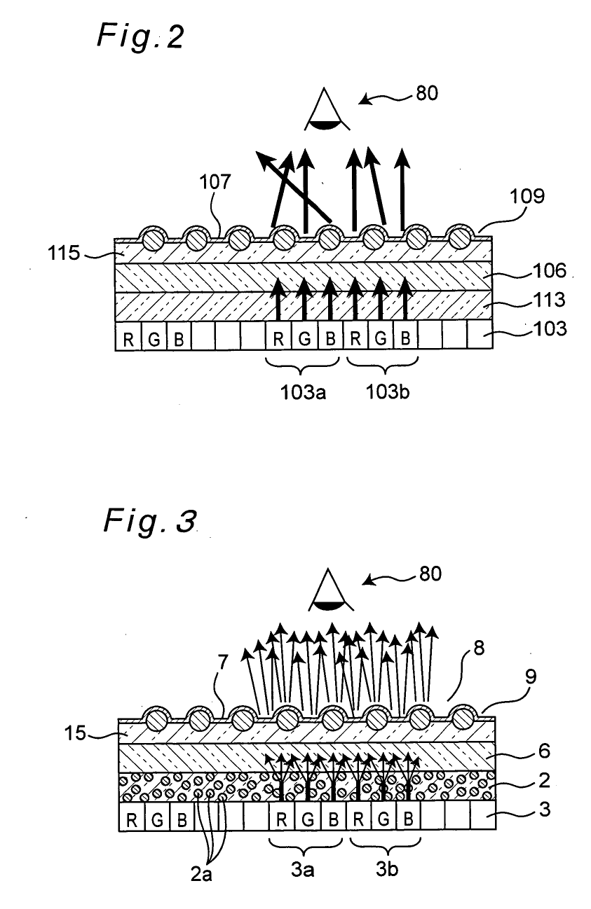

FIG. 1 and FIGS. 4 to 7 are cross-sectional views showing mounting structures for a touch panel according to the first embodiment of the present invention, FIG. 2 is a schematic view explaining the optical operation in a mounting structure for a touch panel having a satin finished surface according to the prior art, and FIG. 3 is a schematic view explaining the optical operation in the mounting structure for a touch panel having a satin finished surface according to the first embodiment of the present invention. In the drawings, reference numeral 1 denotes a touch panel, 2 a transparent diffusion adhesive layer as a first example of a diffusion bonding member, 3 a full-color display on which the touch panel 1 is bonded and fixed by the diffusion adhesive layer 2 (e.g., liquid crystal or organic EL (Electro Luminescence) displays), 3a, 3b pixels of the display 3, 4 a transparent upper insulating substrate, 5 an upper electrode made of transparent conductive film, 6 a transparent lower insulating substrate, 7 a lower electrode made of transparent conductive film, 8 an air layer, 9 a satin finished surface, 14 a double-faced adhesive tape, and 15 a mat coating layer.

The display 3 is a display used in cordless telephone sets, cell phone sets, calculators, subnotebook personal computers, PDAs (Personal Digital Assistants), digital cameras, video cameras, or business communication equipment, and the touch panel 1 is mounded on the front surface of portable electronic equipment equipped with the display 3 as well as the front surface of the monitor of a personal computer, so that the touch panel 1 is used as input equipment in which the surface of the touch panel 1 is pressed by pens or fingers in accordance with instructions appeared through the display screen for allowing execution of various operations.

A mounting structure for the touch panel 1 shown in FIG. 1 comprises a touch panel 1 which is composed of an upper electrode plate having the upper electrode 5 made of transparent conductive film formed on the lower surface of the upper insulating substrate 4 made of plastic film, and a lower electrode plate having the lower electrode 7 made of transparent conductive film formed on the upper surface of the lower insulating substrate 6 made of plastic film, the upper electrode plate and the lower electrode plate being bonded and fixed to each other by the rectangular frame-like double-faced adhesive tape 14 so that the upper electrode plate and the lower electrode plate are disposed opposite to each other with the air layer 8 interposed in between the electrodes 5 and 7 which face each other, and which has the satin finished surface 9 formed on at least either facing surface of the upper insulating substrate 4 and the lower insulating substrate 6, wherein with use of the diffusion bonding member 2, the touch panel 1 and the display 3 are directly and entirely bonded.

As each of the upper insulating substrate 4 and the lower insulating substrate 6 of the touch panel 1, there may be used plastic film such as PET (polyethylene terephthalate), PC (polycarbonate), PES (polyester sulfone), PAR (polyarylate), or ARTON (trade name of a norbornene type of heat resistant transparent resin registered by JSR Corporation). Further, the upper surface of the upper insulating substrate 4 is often subjected to hard coating generally with acrylic UV resin and the like (unshown).

As a means to form the satin finished surface 9, there is often used mat coating processing in which an ink is manufactured with fillers dispersed as light diffusing agents, and in which the plastic film for use as the upper insulating substrate or the lower insulating substrate is coated with the ink by a roll coater, a gravure coater, or the like, and the satin finishing level is controlled by a particle size and a dispersion amount of the fillers contained in the mat coating layer 15 positioned on the plastic film for use as the upper insulating substrate or the lower insulating substrate. It is naturally possible to apply other stain finishing treatment such as embossing to form the satin finished surface 9 on the upper insulating substrate 4 and/or the lower insulating substrate 6. However, in many cases, a hard coat ink has conventionally been used to coat the upper insulating substrate 4 and the lower insulating substrate 6 to form a base for formation of transparent conductive film, and if the fillers are dispersed into the hard coat ink to produce an ink used also for mat coating, then formation of the hard coat layer and formation of the mat coating layer 15, i.e., formation of the satin finished surface 9, can be performed simultaneously, which makes the mat coating processing more preferable than other satin finishing treatment in terms of cost and efficiency. As a filler for use as a light diffusing agent in the mat coating processing, there are used SiO₂ particles, Al₂O₃ particles, or the like with a particle size of not more than 3 μm. The filler with a particle size of more than 3 μm is not desirable because if it is used, then a protrusion portion of the filler makes the distance between the upper and the lower electrodes of the touch panel 1 too short, causing the possibility of input errors during input operation.

Moreover, the level of satin finishing treatment applied to at least either facing surface of the upper insulating substrate 4 and the lower insulating substrate 6 is expressed by surface haze, and it is preferable to apply the satin finishing treatment with surface haze of 1.5 to 5%. If the surface haze is more than 5%, the touch panel itself looks white, and visibility of the display is considerably deteriorated. In schematic explanation, even if high contrast with white characters on a black background is secured when the display 3 is used as a single unit as shown in FIG. 12, the contrast is degraded to gray characters on a gray background when the display 3 is used in combination with the touch panel 1 as shown in FIG. 13, resulting in considerable deterioration in visibility of the display 3. If the surface haze is less than 1.5%, protection against generation of Newton rings is decreased. It is to be noted that the surface haze in the present invention is defined as haze (haze value) obtained by the test in conformity with JIS K 7105 (1981) when the satin finishing treatment identical to that applied to the upper insulating substrate 4 and the lower insulating substrate 6 is applied to highly transparent PET film. The highly transparent PET film for use should have the haze of the film itself being not more than 0.5%.

Description is hereinbelow given of the test in conformity with JIS K 7105 (1981).

The gist of the test is as follows.

As to light transmittance in the case where a test piece is thin or where a haze value is small even if the test piece is thick, the total light transmission amount and the scattered light amount are measured based on a measuring method A with use of an integrating sphere type measuring apparatus so as to obtain a total light transmittance, a diffuse transmittance, and a difference therebetween as a parallel light transmittance.

Measurement based on the measuring method A is as follows.

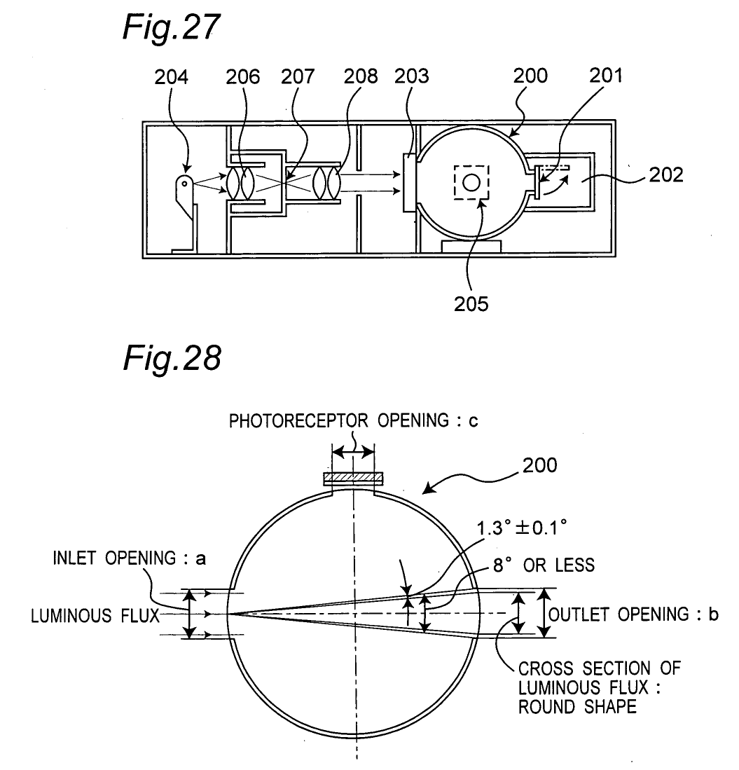

FIG. 27 and FIG. 28 are views showing the optical principle of the integrating sphere type light transmittance measuring apparatus in the measuring method A. The apparatus is required to satisfy the optical conditions shown below.

As a condition of an integrating sphere 200, a sum (a+b+c) of the areas of inlet and outlet of light (attaching portions of a test piece and a standard white plate) is set at not more than 4% of the entire internal surface area of the sphere (see FIG. 28). The center line between the inlet and the outlet is on the same great circle of the sphere, and an angle of the diameter of the outlet against the inlet is 8° or less.

As a condition of a reflecting surface, a standard white plate 201 is set to have constant high reflectivity with respect to all wavelengths of visible light. Magnesium oxide, barium sulfite, aluminum oxide, or the like is suitable as a material of the standard white plate 201. The inner wall of the integrating sphere is coated with a material having reflectivity identical to that of the standard white plate 201.

As a condition of luminous flux, luminous flux shed on a test piece should be composed of almost parallel ray of light which is not misaligned by 3° or more from an optical axis. The center of the luminous flux is equal to the center of the outlet. The cross-section of the luminous flux in the outlet should be in a round shape and should be clear. Moreover, an angle of the diameter against the center of the inlet is set smaller than the angle against the radius of the outlet by 1.3±0.1°. The cross-section of the luminous flux in the outlet of the integrating sphere is as shown in FIG. 28.

As a condition of a light trap 202, the light trap should completely absorb light when a test piece 203 or the standard white plate are not mounted.

As a condition of a light source 204, standard light A is used as a light source.

As a condition of a photoreceptor 205, the overall sensitivity of the photoreceptor should satisfy a value Y, which is a router condition in standard light C using a luminosity filter. However, if it is specifically stated, measurement may be conducted with a photoreceptor which satisfies a value Y that is a router condition in standard light A. It is to be noted that in the drawing, reference numeral 206 denotes a lens, 207 an aperture, and 208 a lens.

The test piece for use in the measurement method A is as follows. The size of the test piece is 50×50 mm, and its thickness is an original thickness. Three test pieces are used herein.

The measurement based on the measurement method A is carried out as follows.
(a) The standard white plate is mounted on an apparatus, and the indication of the apparatus is set at 100 (T₁) to adjust the amount of incident light.
(b) In the state that the standard white plate is mounted, the test piece is mounted to measure the total light transmission amount (T₂).
(c) The standard white plate and the test piece are dismounted, and a light trap is mounted to measure the scattered light amount (T₃) of the apparatus.
(d) In the state that the light trap is mounted, the test piece is mounted to measure the scattered light amount (T₄) by the apparatus and the test piece.

In a calculating method based on the measurement method A, the following equation is used to calculate the total light transmittance, the diffuse transmittance, and the parallel light transmittance.
Tt=T₂
T_{d}=T₄−T₃ (T₂/100)
Tₚ=Tₜ−T_{d}
wherein Tₜ represents the total light transmittance (%)
T_{d} represents the diffuse transmittance (%), and
Tₚ represents the parallel light transmittance (%).

In terms of expression of the result of the measurement method A, the total light transmittance, the diffuse transmittance, and the parallel light transmittance are calculated down to the first decimal place and expressed as the example shown below.
Ex.: Tₜ=91.2 (%), T_{d}=3.6 (%), Tₚ=87.6 (%)

It is to be noted that although the satin finished surface 9 may be formed on both the facing surfaces of the upper insulating substrate 4 and the lower insulating substrate 6, such a construction has disadvantage in cost, and then it is preferable to form it on either one of the surfaces. In that case, the satin finished surface 9 is more preferably formed on the side of the lower insulating substrate 6. This is because the lower insulating substrate 6 is free from deformation during input operation to the touch panel, so that the lower insulating substrate 6 is less susceptible to deterioration of adhesion between the satin finished surface 9 and the transparent conductive film than the upper insulating substrate 4.

As materials of the transparent conductive film for use in each of the upper electrode 5 and the lower electrode 7, there are metallic oxide such as stannic oxide, indium oxide, antimony oxide, zinc oxide, cadmium oxide, and ITO, as well as metal thin film such as gold, silver, copper, tin, nickel, aluminum, and palladium. These transparent conductive films are formed by vacuum evaporation method, sputtering method, ion plating method, or CVD method. It is to be noted that the transparent conductive film provided by the aforementioned forming method is so thin that it is provided along the asperity of the satin finished surface 9 on the upper insulating substrate 4 and/or the lower insulating substrate 6, thereby turning the electrode surface also into a stain finished surface.

Further, on the respective upper electrode plate and the lower electrode plate, there is formed a circuit with a specified pattern such as bus bars and routing lines (unshown). As a material of the circuit, there may be used metal such as gold, silver, copper, and nickel; or paste having conductivity such as carbon. The circuit is formed by printing method such as screen printing, offset printing, gravure printing, or flexographic printing; photoresist method; or brush coating method.

It is to be noted that the upper electrode plate and the lower electrode plate are normally away from each other with spacers formed on the surface of the upper electrode 5 or the lower electrode 7, and only when pressure is put on the upper electrode plate by fingers or pens, the upper electrode 5 and the lower electrode 7 are brought into contact with each other to execute input operation. The spacers may be obtained by forming transparent photocurable resin into fine dots through the photo process. Also, a plurality of fine dots may be formed by the printing method to produce the spacers. Further, the upper electrode plate and the lower electrode plate are stuck to each other by the double-faced adhesive tape 8 or a transparent adhesive only at the area out of the display region. If the size of the touch panel 1 is small and this bonding is enough to maintain insulation between the upper and lower electrodes, then the spacers may be omitted.

In the feature of the first embodiment of the present invention, in the mounting structure for a touch panel, in which the touch panel 1 having the satin finished surface 9 on at least either facing surface of the upper insulating substrate 4 and the lower insulating substrate 6 as described above is mounted on the display 3, the touch panel 1 and the display 3 are entirely bonded by the diffusion adhesive layer 2.

In the prior art, a typical adhesive layer 113 used for entire bonding between the touch panel 101 and the display 103 permits visible light from the display 103 to intactly pass through the layer and then vertically come incident to the touch panel 101. When the visible light incident to the touch panel 101 then passes through a satin finished surface 109 formed on the facing surfaces of the upper insulating substrate 104 or/and the lower insulating substrate 106 on the touch panel 101, the light comes incident on a slant to protruding surface portions or recessed surface portions constituting the satin finished surface 109 and is refracted. In this case, the index of refraction differs depending on wavelengths of passing light, and more specifically, red-color light with longer wavelengths is refracted at a small angle while blue-color light with shorter wavelengths is refracted at a large angle, so that after passing the satin finished surface 109, respective RGB (Red, Green, and Blue) colored rays of light from the display 103 travel in slightly different direction due to difference in index of refraction between wavelengths of the respective RGB rays of light. Furthermore, even if light having the color or the same wavelength comes incident to the touch panel 101 at the same angle, its traveling direction differs depending on at which point of the satin finished surface 109 the light is refracted, i.e., at which angle the light comes incident to the protruding surface portions or to the recessed surface portions constituting the satin finished surface 109 (see FIG. 2). Therefore, for example, even if RGB light emission is conducted such that totally identical additive color mixture is applied to a certain pixel 103a and an adjacent pixel 103b on the screen of the display 103, displayed colors of the pixel 103a and the pixel 103b recognized by a viewer 80 at the final stage are sometimes different. The more the display 103 becomes high definition, i.e., the finer the pixels become, the more the number of pixels which suffer from aforementioned phenomenon increases, and therefore the screen looks like glaring.

The diffusion adhesive layer 2 in the touch panel in the first embodiment of the present invention is composed of an acrylic transparent adhesive such as acrylic ester and fillers 2a dispersed as light diffusing agents in the adhesive, and the visible light from the display 3 is refracted and reflected by the fillers 2a. More particularly, visible light from the display 3 is scattered in advance in multi-directions before being incident to the touch panel 1 (see FIG. 3). In the conventional case where the visible light from the display 103 intactly passes and then vertically comes incident to the touch panel 101, the traveling direction of the light having the color of the same wavelength which passed through the same point on the satin finished surface 109 is almost one direction. However, in the case where the light is scattered in advance in multi-directions before coming into incident to the touch panel 1 as with the first embodiment of the present invention, light having the color of the same wavelength which passed through the same point on the satin finished surface 9 has multiple traveling directions. Eventually, significant difference no longer exists no matter at which point of the satin finished surface 9 the light is refracted, and therefore, even if, for example, RGB light emission is conducted such that totally identical additive color mixture is applied to a certain pixel 3a and an adjacent pixel 3b on the screen of the display 3, displayed colors of the pixel 3a and the pixel 3b recognized by the viewer 80 at the final stage are no longer different. As a result, even if the display 1 is high definition, the screen does not look like glaring.

The term “high definition” in this invention generally refers to 100 ppi (pixel per inch: equal to dpi) or more. The present invention does not necessarily need to be applied but is preferably applied to the display with definition of 10 ppi, whereas the present invention is surely applied to the display with definition of 200 ppi or more.

It is to be noted that in the case where the satin finished surface 9 is formed by mat coating processing, though scattering occurs due to fillers in the mat coating layer 15, the larger amount of fillers deteriorates durability of the mat coating layer 15 against input operation and causes removal of the mat coating layer 15 together with the transparent conductive film, which makes it impossible to disperse a sufficient amount of fillers and thereby making it difficult to suppress the glare. In the first embodiment of the present invention, scattering is achieved by the fillers 2a in the diffusion adhesive layer 2 protected by the lower insulating substrate 6 and the like, which prevents the problem of deteriorated durability against input operation even if the sufficient amount of the fillers 2a is dispersed.

The diffusion adhesive layer 2 is composed of an acrylic transparent adhesive such as acrylic ester and fillers 2a dispersed as light diffusing agents in the adhesive. As the acrylic adhesive, an adhesive generally used in adhesive tapes and the like may be adopted. Further, as the fillers 2a dispersed as light diffusing agents, there are used SiO₂ particles, Al₂O3 particles, or the like with a particle size of approx. 1 μm.

Moreover, the level of dispersion of the fillers 2a in the diffusion adhesive layer 2 may be expressed by the haze (haze value) of the diffusion adhesive layer 2 itself which is obtained by JIS K 7105 (1981), and the haze of the diffusion adhesive layer 2 is adjusted to be 10 to 50%. If the haze of the diffusion adhesive layer 2 is less than 10%, it becomes difficult to suppress interference between the satin finishing treatment of the touch panel and pixels of the display. If the haze of the diffusion adhesive layer 2 is beyond 50%, the adhesive layer itself is whitened and visibility of the display 3 is degraded. More preferable haze of the diffusion adhesive layer 2 is 25 to 35%. Moreover, the thickness of the diffusion adhesive layer 2 needs to be at least 10 μm so as to obtain adhesive strength.

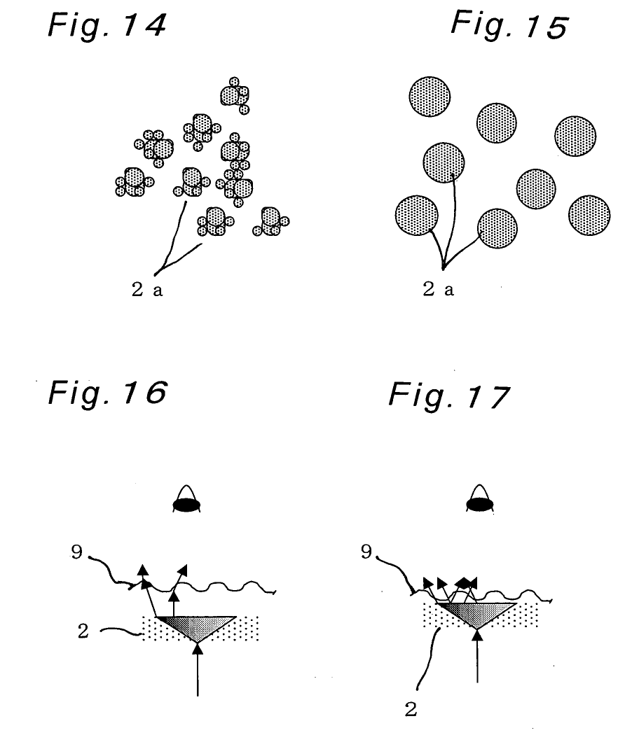

The particle size of the fillers 2a in the diffusion adhesive layer 2 is required to be equal to or larger than the wavelength of the visible light (400 nm to 700 nm. i.e., 0.4 μm to 0.7 μm) since visible light need to be diffused generally by the fillers 2a. More preferably, the particle size is around 2 to 3 μm. Moreover, the fillers 2a may be subjected to primary aggregation and secondary aggregation as shown in FIG. 14 so as to wholly have a particle size of approx. 2 to 3 μm for dispersion. In that case, fillers with different particle sizes may be used. Since it is not necessary to uniform the particle size in advance, this case is beneficial in view of material costs. However, in consideration of dispersibility, mono-dispersion of fillers with an identical particle size of approx. 2 to 3 μm as shown in FIG. 15 is preferable as uniform effect can be secured. However, mixed usage of different kinds of filler is not recommended.

Although description above has been given of the mounting structure shown in FIG. 1, the present invention is not limited thereto.

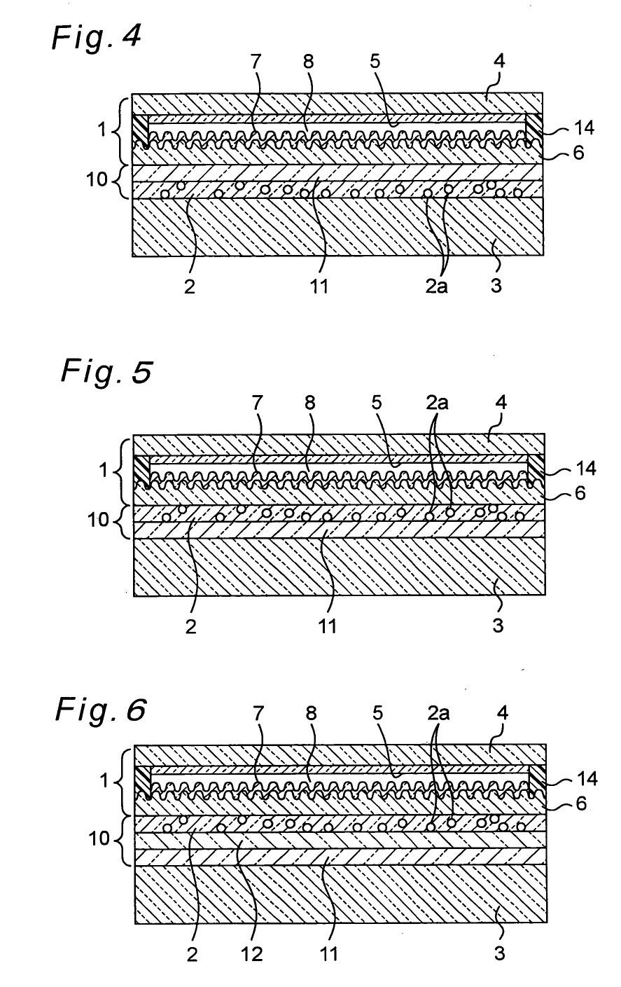

For example, the touch panel 1 and the display 3 may not necessarily be bonded directly through the diffusion adhesive layer 2. More specifically, as shown in FIG. 4 as a first modification of the first embodiment, a transparent mounting sheet (second example of the diffusion bonding member) 10 composed of a silicon rubber sheet 11 and a diffusion adhesive layer 2 laid on one surface of the silicon rubber sheet 11 is prepared, the diffusion adhesive layer 2 of the mounting sheet 10 is entirely bonded to the top surface of the display 3, and the touch panel 1 is stuck to and mounted on the top surface of the silicon rubber sheet 11 of the mounting sheet 10 which is bonded and fixed to the top of the display 3 (see FIG. 4). This allows easy dismounting of the touch panel 1 from the silicon rubber sheet 11 and allows easy re-sticking of the silicon rubber sheet 11 to the touch panel 1.

Furthermore, as shown in FIG. 5 as a second modification of the first embodiment, a transparent mounting sheet (second modification of the diffusion bonding member) 10 composed of a silicon rubber sheet 11 and a diffusion adhesive layer 2 laid on one surface of the silicon rubber sheet 11 is prepared, the diffusion adhesive layer 2 of the mounting sheet 10 is entirely bonded to the rear surface of the touch panel 1, and the display 3 can be stuck to and mounted on the top surface of the silicon rubber sheet 11 of the mounting sheet 10 which is bonded and fixed to the touch panel 1 (see FIG. 5). This allows easy dismounting of the display 3 from the silicon rubber sheet 11 and allows easy re-sticking of the silicon rubber sheet 11 to the display 3.

Although the silicon rubber sheets 11 of the respective mounting sheets 10 in FIG. 4 and FIG. 5 are resistant to separating force acting in vertical direction on the contact face to separate a bonded article and also resistant to displacement force directing along the contact face, if the silicon rubber sheet 11 is subjected to separating force to separate it from the bonded article such as pulling the silicon rubber sheet 11 off from the end portion of the silicon rubber sheet 11, then the silicon rubber sheet 11 tends to be easily removed from the bonded article, which allows repair in the mounting structure for the touch panel 1 using the mounting sheet 10. As the silicon rubber sheet 11, there may be used, for example, a sheet formed by producing an ink from mixture of silicon rubber and silicon resin with the aide of solvent, applying the ink and crosslinking the applied ink with heat during drying operation. The thickness of the silicon rubber sheet 11 preferably is in the range of 20 to 100 μm. If the thickness is 20 μm or more, the silicon rubber sheet 11 is high in elasticity and functions as a shock absorber so as to be able to protect the display 3 from various impacts and deformations. If the thickness is more than 100 μm, then adhesive force becomes too strong, which prevents easy removal of the touch panel 1 from the side of the silicon rubber sheet 11 on the mounting sheet 10 and tends to trap bubbles when the touch panel 1 is mounted on the display 3.

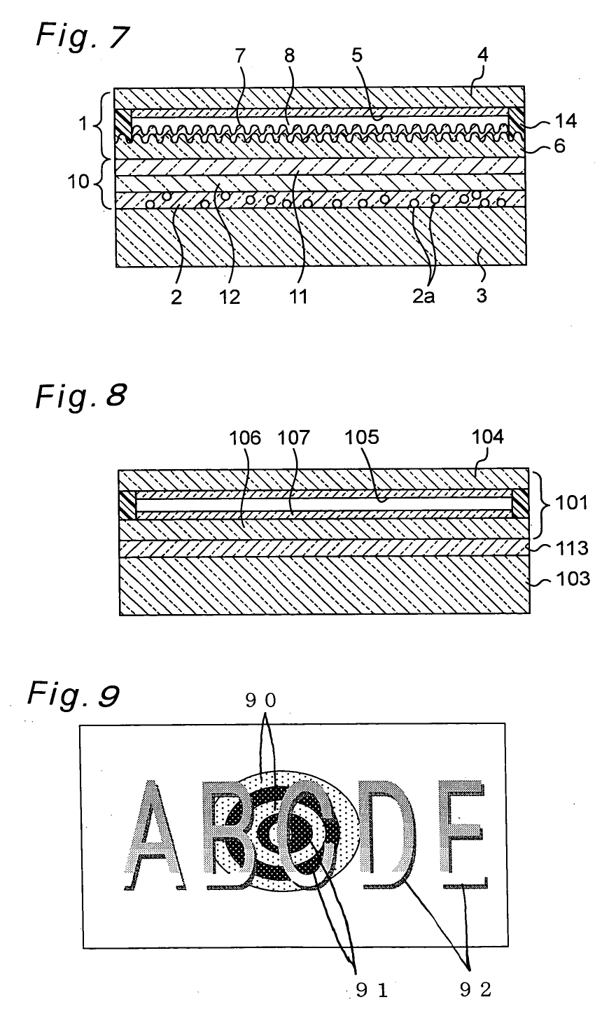

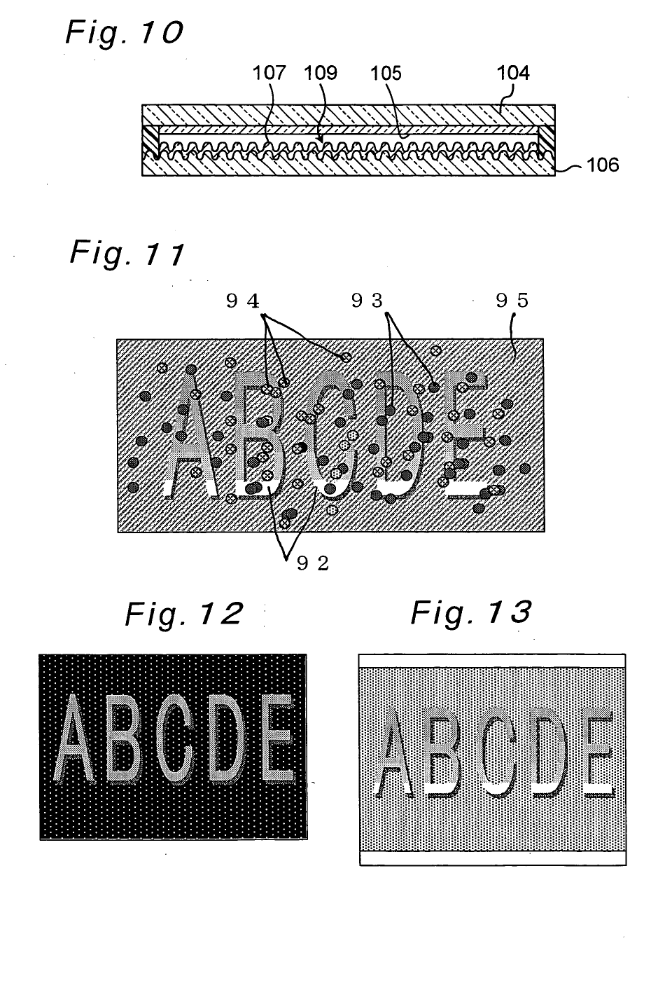

Moreover, in third and fourth modifications of the first embodiments, a mounting sheet (another second modification of the diffusion bonding member) 10 may be composed of the diffusion adhesive layer 2 and the silicon rubber sheet 11 with a plastic film functioning as a core 12 interposed therebetween (see FIG. 6 and FIG. 7). In FIG. 6, the core 12 is interposed in between the silicon rubber sheet 11 disposed on the display 3 and the diffusion adhesive layer 2 disposed on the side of the touch panel 1. In FIG. 7, the core 12 is interposed in between the diffusion adhesive layer 2 disposed on the display 3 and the silicon rubber sheet 11 disposed on the side of the touch panel 1.

Thus, when the mounting sheet 10 is provided on the back surface of a large-sized panel incorporating a number of touch panels 1 and then the mounting sheet 10 is die-cut together with each of the touch panel 1, the mounting sheet 10 having elasticity enhanced by the core 12 can be die-cut into a specified shape at high accuracy. As a material of the plastic film to form the core 12, there may be used, for example, transparent film such as PET (polyethylene terephthalate), PC (polycarbonate), TAC (triacetyl cellulose), or PES (polyester sulfone). It is to be noted that the thickness of the plastic film to form the core 12 preferably is 12 μm or more. This is because with the thickness of less than 12 μm, elasticity cannot be sufficiently enhanced. Moreover, with the thickness less than 12 μm, when the silicon rubber sheet 11 is coated with the ink, the core 12 is undulated to make it difficult to control the thickness to be even, and bubbles tend to be trapped when the touch panel 1 is mounted on the display 3.

It is to be noted that the surface of the core 12 on which the silicon rubber sheet 11 is laid is preferably subjected to primer treatment. The primer treatment generally refers to application of an intermediate agent compatible to both a base material and a coating agent for improving adhesiveness between the base material and the coating agent. In the broad sense, the treatment refers to easy-adhesion treatment including providing asperity on the surface of the base material to increase the surface area and enhance adhesiveness, as well as surface modification through corona treatment and the like to increase adhesiveness. The primer treatment makes it possible to fixedly adhere the silicon rubber sheet 11 to the core 12 and thus, prevent removal of the core 12 from the silicon rubber sheet 11 when the touch panel 1 is removed, and to prevent the core 12 and the silicon rubber sheet 11 from being out of alignment during die-cutting to cause the silicon rubber sheet 11 to sticking out.

Moreover, the diffusion adhesive layer 2, if applied to the mounting sheet 10, is preferably given the upper limit of 50 μm. With a thickness of more than 50 μm, adhesive strength becomes too strong, which makes it difficult to discharge bubbles even if the bubbles which are generated or is already generated between the diffusion adhesive layer 2 and a bonded article are subjected to defoaming treatment such as applying pressure so as to gradually discharge the bubbles with a roller and the like while applying R curve to the mounting sheet 10, and placing the diffusion adhesive layer 2 in a reduced-pressure atmosphere.

Moreover, in coating during manufacturing process of the mounting sheet 10, i.e., coating with a coating agent during the primer treatment, coating during formation of the diffusion adhesive layer 2, and coating during formation of the silicon rubber sheet 11, there are adopted general coating techniques including gravure coating, reverse coating, comma coating, and die coating.

Further, in terms of disposition of the diffusion adhesive layer 2, as shown in FIG. 16 and FIG. 17, when the distance between the diffusion adhesive layer 2 and the satin finished surface 9 is smaller (the distance is smaller in FIG. 17 than that in FIG. 16), finer light diffusion is achieved and therefore larger antiglare effect from the view point of human eyes is obtained.

Moreover, there is a modification of the diffusion adhesive layer 2, which is formed such that when the core (optical isotropic film) 12 of the mounting sheet 10 is produced as a film by melt extrusion method or solution casting method, diffusion fillers 2a such as SiO₂ or Al₂O₃ are dispersed together with resin pellets, and a haze value is adjusted to be 10 to 50%.

Further, as for providing the diffusion adhesive layer 2, there are following functions to improve the effects peculiar to the touch panel. That is, when the touch panel 1 is used, input operation by pens or fingers are repeated, which generates some stains and flaws on the top surface and the inner surface. However, in the touch panel 1 in the first embodiment, due to the influence of light diffusion, the stains and flaws fall into obscurity, giving advantage to appearance.

Following description discusses the comparison between working examples 1 to 3 of the first embodiment of the present invention and a comparative example 1.

### WORKING EXAMPLE 1

A PET film with a thickness of 188 μm was used as the lower insulating substrate, its upper surface was mat- coated by a roll coater with a 5 μm-thick acrylic resin having SiO₂ particles with a particle size of 2 μm which were dispersed as light diffusing agents, and was subjected to satin finishing treatment to form a satin finished surface having surface haze of 3%, and a lower electrode made of a 20 nm-thick ITO film was formed on the satin finished surface by sputtering to form a lower electrode plate. Further, a 188 μm-thick PET film was used as the upper insulating substrate, its lower surface was coated with a 5 μm-thick acrylic resin by a roll coater, an upper electrode made of a 20 nm-thick ITO film was formed on the coating layer by sputtering, and the surface of the upper insulating substrate opposite to the surface on which the upper electrode was formed was coated with 5 μm-thick acrylic resin by a roll coater to form the upper electrode plate. Next, after a circuit with a specified pattern was formed on the upper electrode plate and the lower electrode plate by screen printing, the upper electrode plate and the lower electrode plate were disposed so as to face each other with an air layer interposed in between the electrodes, and both the plates were bonded at a periphery portion with a double-faced adhesive tape to obtain a touch panel which prevents Newton rings from being generated between both the electrodes.

The back surface of the touch panel was coated by screen printing with an ink composed of an adhesive layer made of acrylic ester and SiO₂ particles with a particle size of 1 μm dispersed as light diffusing agents in the adhesive layer, by which a diffusion adhesive layer with a thickness of 20 μm and haze of 25% was formed on the entire surface. Next, the touch panel with the diffusion adhesive layer was stuck to the entire top surface of a high-definition color LCD while pressure was applied by a roller.

### WORKING EXAMPLE 2

With use of a transparent polyester film with a thickness of 38 μm, a width of 1050 mm, and a length of 500 m as a core, first, one surface of the polyester film was subjected to surface modification by corona discharge, a 40 μm-thickness silicon rubber sheet was laid on the surface by a coater, and a polyester film subjected to mold-releasing was laminated on the surface of the silicon rubber sheet as a separator. Next, the other surface of the core was coated by a roll coater with an ink composed of an adhesive layer made of acrylic ester in which Al₂O₃ particles with a particle size of 1 μm were dispersed, by which a diffusion adhesive layer with a thickness of 25 μm and haze of 20% was obtained. Polyester films subjected to mold-releasing were laminated on the surfaces as separators to obtain a roll sheet provided with separators on both surfaces. Then, the sheet was cut into a size of 500 mm wide and 500 mm long, the separator on the diffusion adhesive layer side was removed, the sheet was stuck to the entire back surface of a large-sized panel incorporating a number of touch panels similar to those manufactured in the working example 1, and the panel was die-cut into each touch panel with a size of 70 mm width and 90 mm long by a cutting tooth form. At last, after the remaining separator was removed, the touch panel was stuck to the entire top surface of a high-definition color LCD.

### WORKING EXAMPLE 3

The constructions similar to those in the working example 2 were provided except that a mounting sheet with separators with a size of 70 mm wide and 90 mm long was used, the separator on the diffusion adhesive layer side was removed, and the sheet was stuck to the entire top surface of a high-definition color LCD, before the remaining separator was removed and a touch panel is stuck thereto.

### COMPARATIVE EXAMPLE 1

With use of a commercially available adhesive sheet which was composed of a 20 μm-thick adhesive layer made of acrylic ester and was provided with a double-faced separator, one separator was removed and the sheet was stuck to the back surface of the touch panel similar to that manufactured in the working example 1, while another separator was removed and the sheet was stuck to the entire top surface of a high-definition color LCD.

As a result of observing visibility of LCD display in the mounting states in the working examples 1 to 3 and the comparative example 1, color bleeding and glare were not seen in the working examples 1 to 3, and their display bore comparison with the display by an LCD as a single unit. However, in the comparative example 1, bleeding (glare) occurred and thereby visibility was degraded.

The mounting structure for a touch panel in the first embodiment of the present invention is constituted as described above and therefore the following effects are achieved.

That is, in the mounting structure composed of the touch panel which has the satin finished surface formed on at least either facing surface of the upper insulating substrate and the lower insulating substrate, and which is mounted on the display, the touch panel and the display are entirely bonded to each other by the diffusion adhesive layer exemplifying the diffusion bonding member, so that visible light from the display is scattered in multi-directions in advance by the fillers contained in the diffusion adhesive layer before the light is incident to the touch panel. As a result, there is no longer significant difference in the traveling direction of light no matter at which point of the satin finished surface the light is refracted, and therefore, in the case where, for example, RGB light emission is conducted such that totally identical additive color mixture is applied to a certain pixel and an adjacent pixel on the screen of the display, displayed colors of both the pixels recognized by a viewer at the final stage are no longer different. Therefore, even if the display is high definition, the screen does not look like glaring.

Next, a touch panel with a support plate and a mounting structure for the touch panel according to each of second to fourth embodiments of the present invention are composed of a touch panel in which a satin finished surface is formed on at least either facing surface of an upper insulating substrate and a lower insulating substrate each made of plastic film, and the support plate made of a plastic plate is stuck to the back surface of the lower insulating substrate, and also relates to a touch panel with a support plate and a mounting structure for the touch panel capable of suppressing glare on the display screen even in the state of being mounted on a display.

Before detailed description of the mounting structures for the touch panels according to the second to fourth embodiments proceeds, description is given of the prior art.

In these days, emphasis is being given to development of products such as the aforementioned personal computers with smaller weight, and this requires development of a touch panel 101A itself with smaller weight, which usually results in adoption of a type of the lower insulating substrate 106 made of plastic film. In this case, after the lower electrode 107 is formed on the lower insulating substrate 106 made of plastic film, a support plate 129 made of a plastic plate is stuck to the back surface of the lower insulating substrate 106 so as to ensure resistance against pressure application during input operation (see FIG. 21). It is to be noted that the lower electrode is not directly formed on the plastic plate because, among other reasons, a high-quality lower electrode is not available since the degree of vacuum is not increased during formation of an electrode film in a vacuum atmosphere due to a large quantity of outgas generated from the plastic plate (degassing), and since the lower electrode should be formed at a low temperature as it is less easy to apply tension compared to the plastic film.

However, the plastic film, if used as the lower insulating substrate 106, causes an issue that Newton rings are generated when the display is viewed through the touch panel 101A. The generation mechanism of the Newton rings in the touch panel 101A is such that the upper insulating substrate 104 made of plastic film sags in the manufacturing process and the like of the touch panel 101A, so that light reflected by the upper surface and the lower surface of a thin air layer 108 disposed between the upper electrode and the lower electrode interferes, and so the interference fringes appear as contrasting concentric circles. If the lower insulating substrate 106 is a glass plate with dimensional stability, then it is possible to apply treatment such as heating to the touch panel 101A so as to tauten the upper insulating substrate 104 made of plastic film for preventing generation of the Newton rings. In the case where the plastic film is used as the lower insulating substrate 106 as described above, the lower insulating substrate 106 and the support plate 129 are also poor in dimensional stability, and therefore it is difficult to tauten the upper insulating substrate 104 even with treatment such as heating being applied.

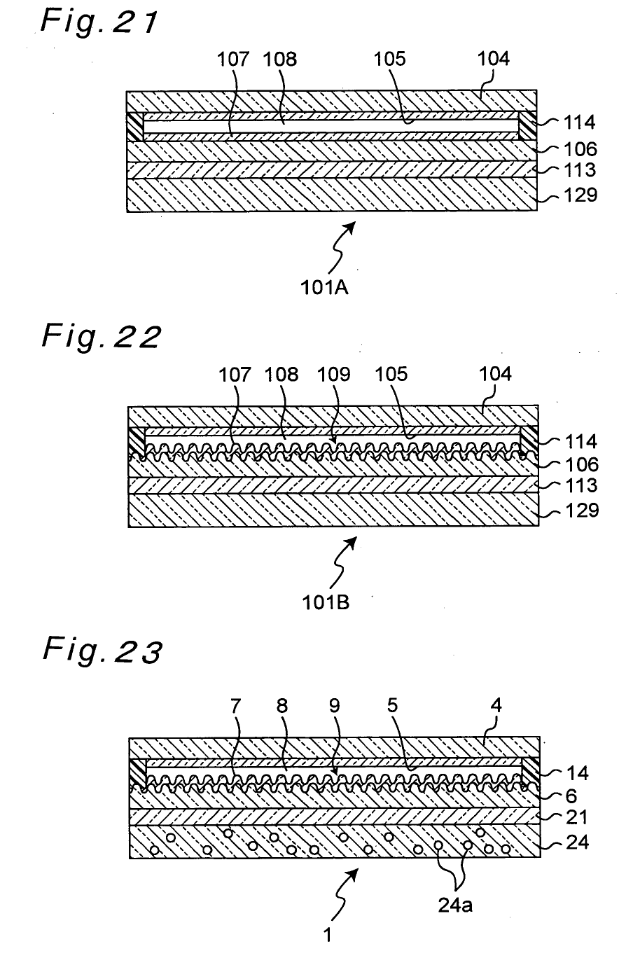

Accordingly, in order to prevent the Newton rings from being generated in a touch panel lO1B having the lower insulating substrate 106 made of plastic film, there has been proposed a method in which at least either facing surface of the upper insulating substrate 104 and the lower insulating substrate 106 is satin finished, and this satin finished surface scatters reflected light so as to make the Newton rings unclear (see FIG. 22).

However, recent high-resolution displays (e.g., displays of 200 dpi or more) create a new kind of issue, that is, mounting a touch panel having the satin finished surface causes degradation of visibility such as “glare38 on the display screen.

Accordingly, an object of the second to fourth embodiments of the present invention is to overcome the forgoing deficiencies and to provide a touch panel with a support plate and a mounting structure for the touch panel capable of suppressing the glare on a display screen when the touch panel is mounted on a display even if a satin finished surface is formed on at least either facing surface of an upper insulating substrate and a lower insulating substrate.

In accomplishing the above object, a touch panel with a support plate in one aspect of the present invention is composed of an upper electrode plate having an upper electrode made of transparent conductive film formed on a lower surface of an upper insulating substrate made of plastic film, and a lower electrode plate having a lower electrode made of transparent conductive film formed on an upper surface of a lower insulating substrate made of plastic film, the upper electrode plate and the lower electrode plate being disposed so as to face each other with an air layer interposed in between the electrodes, and has a satin finished surface formed on at least either facing surface of the upper insulating substrate and the lower insulating substrate, in which a support plate made of a plastic plate as an example of the diffusion bonding member is entirely bonded to the back surface of the lower insulating substrate by a diffusion adhesive layer.

In the above constitution, it is possible to set the haze of the diffusion adhesive layer at 5 to 45%, and the surface haze of the satin finished surface of the touch panel at 1.5 to 5%.

Further, a touch panel with a support plate in another aspect of the present invention is composed of an upper electrode plate having an upper electrode made of transparent conductive film formed on a lower surface of an upper insulating substrate made of plastic film, and a lower electrode plate having a lower electrode made of transparent conductive film formed on an upper surface of a lower insulating substrate made of plastic film, the upper electrode plate and the lower electrode plate being disposed so as to face each other with an air layer interposed in between the electrodes, and has a satin finished surface formed on at least either facing surface of the upper insulating substrate and the lower insulating substrate, in which a support plate made of a plastic plate having diffusivity as an example of the diffusion bonding member is entirely bonded to the back surface of the lower insulating substrate by a diffusion adhesive layer.

Further, in the constitution for bonding the support plate having the diffusivity, it is possible to set the haze of the support plate having diffusivity at 10 to 50%, and the surface haze of the satin finished surface of the touch panel at 1.5 to 5%.

Further, a touch panel with a support plate in still another aspect of the present invention is composed of an upper electrode plate having an upper electrode made of transparent conductive film formed on a lower surface of an upper insulating substrate made of plastic film, and a lower electrode plate having a lower electrode made of transparent conductive film formed on an upper surface of a lower insulating substrate made of plastic film, the upper electrode plate and the lower electrode plate being disposed so as to face each other with an air layer interposed in between the electrodes, and has a satin finished surface formed on at least either facing surface of the upper insulating substrate and the lower insulating substrate, in which a support plate made of a plastic plate having diffusivity as an example of the diffusion bonding member is entirely bonded to the back surface of the lower insulating substrate by a diffusion adhesive layer.

Further, in the constitution for bonding the support plate having the diffusivity by the diffusion adhesive layer, it is possible to set the haze of the support plate which has diffusivity and which is provided with the diffusion adhesive layer on its top surface at 10 to 50%, and the surface haze of the satin finished surface of the touch panel at 1.5 to 5%.

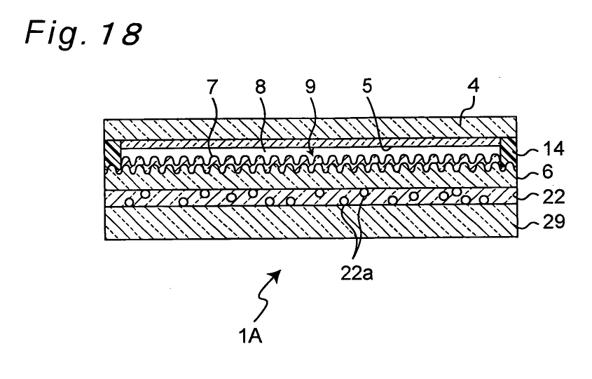

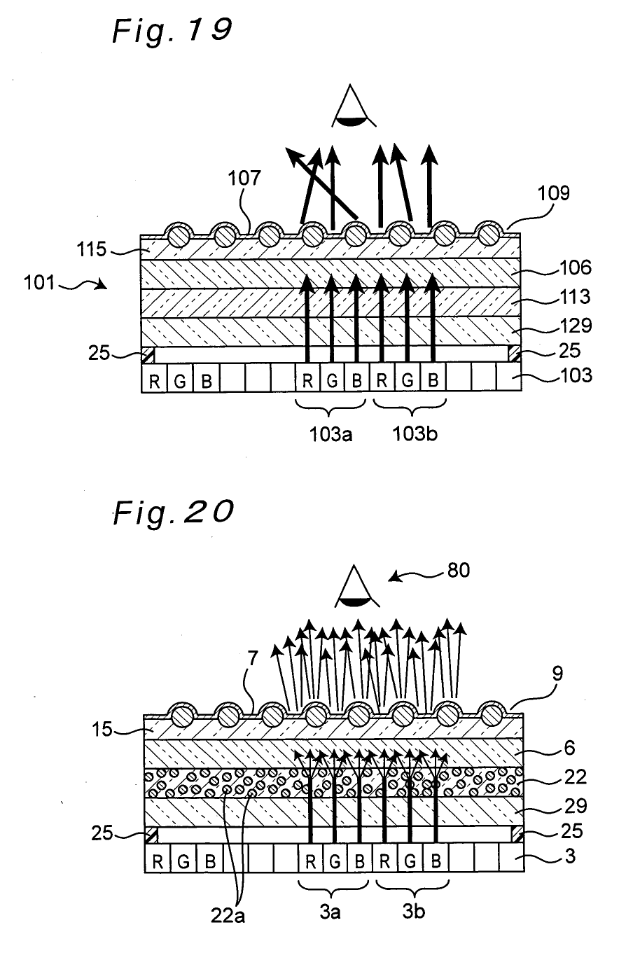

Detailed description is hereinbelow given of the second to fourth embodiments of the present invention with reference to the drawings. FIGS. 18, 23, and 25 are cross- sectional views respectively showing touch panels with support plates according to the second, third and fourth embodiments of the present invention, FIG. 19 is a schematic view explaining the optical operation in a touch panel with a support plate according to the prior art, FIGS. 20, 24 and 26 are schematic views respectively explaining the optical operation in the touch panels with support plates according to the second, third and fourth embodiments of the present invention. In the drawings, reference numeral 1A denotes a touch panel, 5 a transparent upper insulating substrate, 5 an upper electrode made of transparent conductive film, 6 a transparent lower insulating substrate, 7 a lower electrode made of transparent conductive film, 8 an air layer, 9 a satin finished surface, 14 a double-faced adhesive tape, 29 a transparent support plate which functions as a reinforcement of the lower insulating substrate 6 so as to withstand pressure application to the touch panel 1A during input operation and which constitutes a part of a third example of the diffusion bonding member, 22 a transparent diffusion adhesive layer constituting a part of the third example of the diffusion bonding member, 21 a transparent adhesive layer constituting a part of a fourth example of the diffusion bonding member, 15 a mat coating layer, 3 a full-color display to which the support plate 29 of the touch panel 1A is bonded and fixed with a rectangular frame-like adhesive layer 25 (e.g., liquid crystal or organic EL (Electro Luminescence) displays), 3a pixels of the display 3, and 3b a pixel of the display 3.

First, description is given of the first embodiment of the present invention. The touch panel 1A with the support plate, shown in FIG. 18 is composed of an upper electrode plate having the upper electrode 5 made of transparent conductive film formed on the lower surface of the upper insulating substrate 4 made of plastic film, and a lower electrode plate having the lower electrode 7 made of transparent conductive film formed on the upper surface of the lower insulating substrate 6 made of plastic film, the upper electrode plate and the lower electrode plate being bonded and fixed to each other by the rectangular frame-like double-faced adhesive tape 14 so that the upper electrode plate and the lower electrode plate are disposed opposite to each other with the air layer 8 interposed in between electrodes 5 and 7 which face each other, and has the satin finished surface 9 formed on the side of the lower insulating substrate 6 among the facing surfaces of the upper insulating substrate 4 and the lower insulating substrate 6. The support plate 29 made of a plastic plate is entirely bonded to the back surface of the lower insulating substrate 6 by the diffusion adhesive layer 22. It is to be noted that the satin finished surface 9 may be provided on the side of the upper insulating substrate 4 or be provided both the facing surfaces of the upper insulating substrate 4 and the lower insulating substrate 6.

As each of the upper insulating substrate 4 and the lower insulating substrate 6 of the touch panel 1A, there may be used plastic film such as PET (polyethylene terephthalate), PC (polycarbonate), PES (polyester sulfone), PAR (polyarylate), or ARTON (trade name of a norbornene type of heat resistant transparent resin registered by JSR Corporation). The thickness of the upper insulating substrate 4 and the lower insulating substrate 6 is typically 0.05 to 0.2 mm. Further, the upper surface of the upper insulating substrate 4 is often subjected to hard coating generally with acrylic UV resin or the like (unshown).

As a means to form the satin finished surface 9, there is often used mat coating processing in which an ink is manufactured with fillers dispersed as light diffusing agents, and in which the plastic film for use as the upper insulating substrate or the lower insulating substrate is coated with the ink by a roll coater, a gravure coater, or the like, and the satin finishing level is controlled by a particle size and a dispersion amount of the fillers contained in the mat coating layer 15 positioned on the plastic film for use as the upper insulating substrate or the lower insulating substrate. It is naturally possible to apply other stain finishing treatment such as embossing to form the satin finished surface 9 on the upper insulating substrate 4 and/or the lower insulating substrate 6. However, in many cases, a hard coat ink has conventionally been used to coat the upper insulating substrate 4 or the lower insulating substrate 6 to form a base for formation of transparent conductive film, and if the fillers are dispersed into the hard coat ink to produce an ink used also for mat coating, then formation of the hard coat layer and formation of the mat coating layer 15, i.e., formation of the satin finished surface 9, can be performed simultaneously, which makes the mat coating processing more preferable than other satin finishing treatment in terms of cost and efficiency. As a filler for use as a light diffusing agent in the mat coating processing, there may be used SiO₂ particles, Al₂O₃ particles, or the like with a particle size of not more than 3 μm. The filler with a particle size of more than 3 μm is not desirable because if it is used, then a protrusion portion of the filler makes the distance between the upper and the lower electrodes of the touch panel 1A too short, causing the possibility of input errors during input operation.

Moreover, the level of satin finishing applied to at least either facing surface of the upper insulating substrate 4 and the lower insulating substrate 6 may be expressed by surface haze, and it is preferable to apply the satin finishing with surface haze of 1.5 to 5%. If the surface haze is more than 5%, the touch panel itself looks white, and visibility of the display is considerably deteriorated. If the surface haze is less than 1.5%, protection against generation of Newton rings is decreased. It is to be noted that the surface haze in the present invention is defined as haze (haze value) obtained by the test in conformity with JIS K 7105 (1981) when the satin finishing treatment identical to that applied to the upper insulating substrate 4 and the lower insulating substrate 6 is applied to highly transparent PET film. The highly transparent PET film for use should have the haze of the film itself being not more than 0.5%.

It is to be noted that although the satin finished surface 9 may be formed on both the facing surfaces of the upper insulating substrate 4 and the lower insulating substrate 6, such a construction has disadvantage in cost, and then it is preferable to form it on either one of the surfaces. In that case, the satin finished surface 9 is more preferably formed on the side of the lower insulating substrate 6. This is because the lower insulating substrate 6 is free from deformation during input operation to the touch panel 1A, so that the lower insulating substrate 6 is less susceptible to deterioration of adhesion between the satin finished surface 9 and the transparent conductive film than the upper insulating substrate 4.

As materials of the transparent conductive film for use in each of the upper electrode 5 and the lower electrode 7, there are metallic oxide such as stannic oxide, indium oxide, antimony oxide, zinc oxide, cadmium oxide, and ITO, as well as metal such as gold, silver, copper, tin, nickel, aluminum, and palladium. These transparent conductive films are formed by vacuum evaporation method, sputtering method, ion plating method, or CVD method. It is to be noted that the transparent conductive film provided by the aforementioned forming method is so thin that it is provided along the asperity of the satin finished surface 9 on the upper insulating substrate 4 and/or the lower insulating substrate 6, thereby turning the electrode surface also into a stain finished surface.

Further, on the respective surfaces of the upper electrode plate and the lower electrode plate which face the air layer 8, there is formed a circuit with a specified pattern such as bus bars and routing lines (unshown). As a material of the circuit, there is used metal such as gold, silver, copper, and nickel, or paste having conductivity such as carbon. The circuit is formed by printing method such as screen printing, offset printing, gravure printing, or flexographic printing; photoresist method; or brush coating method.

It is to be noted that the upper electrode plate and the lower electrode plate are normally away from each other with spacers formed on the surface of the upper electrode 5 or the lower electrode 7, and only when pressure is put on the upper electrode plate by fingers or pens, the upper electrode 5 and the lower electrode 7 are brought into contact with each other to execute input operation. The spacers may be obtained by forming transparent photocurable resin into fine dots through the photo process. Also, a plurality of fine dots may be formed by the printing method to produce the spacers. Further, the upper electrode plate and the lower electrode plate are stuck to each other by the double-faced adhesive tape 8 or a transparent adhesive only at the area out of the display region. If the size of the touch panel 1A is small and this bonding is enough to maintain insulation between the upper and lower electrodes, then the spacers may be omitted.

Moreover, as the support plate 29 entirely bonded to the back surface of the lower insulating substrate 6, there may be used a transparent plastic plate which can withstand pressure application to the touch panel 1A during input operation such as PC (polycarbonate), PMMA (methacrylate), MS (methyl methacrylate-styrene copolymer), or epoxy. The thickness of the support plate 29 is typically 0.3 to 3.0 mm so as to withstand pressure application to the touch panel 1A during input operation.

In the prior art, a typical adhesive layer 113 used for entire bonding between the lower insulating substrate 106 and the support plate 129 permits visible light from the display 103 to intactly pass through the layer and then vertically come incident to the lower insulating substrate 106. When the visible light incident to the lower insulating substrate 106 then passes through a satin finished surface 109 formed on the facing surfaces of the upper insulating substrate 104 or/and the lower insulating substrate 106 on the touch panel 101, the light comes incident on a slant to protruding surface portions or recessed surface portions constituting the satin finished surface 109 and is refracted. In this case, the index of refraction differs depending on wavelengths of passing light, and more specifically, red-color light with longer wavelengths is refracted at a small angle while blue-color light with shorter wavelengths is refracted at a large angle, so that after passing the satin finished surface 109, respective RGB colored rays of light from the display 103 travel in slightly different direction due to difference in index of refraction between wavelengths of the respective RGB rays of light. Furthermore, even if light having the color of the same wavelength comes incident to the lower insulating substrate 106 at the same angle, its traveling directions differ depending on at which point of the satin finished surface 109 the light is refracted, i.e., at which angle the light comes incident to the protruding surface portions or to the recessed surface portions constituting the satin finished surface 109 (see FIG. 19). Therefore, even if RGB light emission is conducted such that totally identical additive color mixture is applied to a certain pixel 103a and an adjacent pixel 103b on the screen of the display 103 for example, displayed colors of the pixel 103a and the pixel 103b recognized by a viewer at the final stage are sometimes different. The more the display 103 becomes high definition, i.e., the finer the pixels become, the more the number of pixels which suffer from aforementioned phenomenon increases, and therefore the screen looks like glaring.

The diffusion adhesive layer 22 in the touch panel 1A in the second embodiment of the present invention is composed of an acrylic transparent adhesive such as acrylic ester and fillers 22a dispersed as light diffusing agents in the adhesive, and the visible light from the display 3 is refracted and reflected by the fillers 22a. More particularly, the visible light from the display 3 is scattered in advance in multi-directions by the fillers 22a before the light reaches the lower insulating substrate 6 (see FIG. 20). In the conventional case where the visible light from the display 103 intactly passes, and then vertically comes incident to the lower insulating substrate 106, the traveling direction of the light having the color of the same wavelength which passed through the same point on the satin finished surface 109 is almost one direction. However, in the case where the light is scattered in advance in multi-directions by the fillers 22a before coming into incident to the lower insulating substrate 6 as with the touch panel 1A in the second embodiment of the present invention, the light having the color of the same wavelength which passed through the same point on the satin finished surface 9 has multiple traveling directions. Eventually, significant difference no longer exists no matter at which point of the satin finished surface 9 the light is refracted, and therefore, even if, for example, RGB light emission is conducted such that totally identical additive color mixture is applied to a certain pixel 3a and an adjacent pixel 3b on the screen of the display 3, displayed colors of the pixel 3a and the pixel 3b recognized by the viewer 80 at the final stage are no longer different. As a result, even if the display 1A is high definition, the screen does not look like glaring.

As described in the previous embodiment, the term “high definition” in this invention, or more specifically in the second to fourth embodiments, generally refers to 100 ppi (pixel per inch: equal to dpi) or more. The present invention does not necessarily need to be applied but is preferably applied to the display with definition of 10 ppi, whereas the present invention is surely applied to the display with definition of 200 ppi or more.

It is to be noted that in the case where the satin finished surface 9 is formed by mat coating processing, though scattering occurs due to fillers in the mat coating layer 15, the larger amount of fillers deteriorates durability of the mat coating layer 15 against input operation and causes removal of the mat coating layer 15 together with the transparent conductive film, which makes it impossible to disperse a sufficient amount of fillers and thereby making it difficult to suppress the glare. In the second embodiment of the present invention, scattering is achieved by the fillers 22a in the diffusion adhesive layer 22 protected by the lower insulating substrate 6, which prevents the problem of deteriorated durability against input operation even if the sufficient amount of the fillers 22a is dispersed.

The diffusion adhesive layer 22 is composed of an acrylic transparent adhesive such as acrylic ester and fillers 2a dispersed as light diffusing agents in the adhesive. As the acrylic adhesive, an adhesive generally used in adhesive tapes and the like may be adopted. Further, as the fillers 22a which are dispersed as light diffusing agents, there are used SiO₂ particles, Al₂O₃ particles, or the like with a particle size of approx. 1 μm.

Moreover, the level of dispersion of the fillers 22a in the diffusion adhesive layer 22 may be expressed by the haze (haze value) of the diffusion adhesive layer 22 itself which is obtained by the above JIS K 7105 (1981), and the haze of the diffusion adhesive layer 22 is adjusted to be 10 to 50%, preferably 5 to 45%. If the haze of the diffusion adhesive layer 22 is less than 5%, it becomes difficult to suppress interference between the satin finishing treatment of the touch panel and pixels of the display as the diffusion adhesive layer 22 is away from the display. If the haze of the diffusion adhesive layer 22 is beyond 50%, the adhesive layer itself is whitened and visibility of the display 3 is degraded. Furthermore, because of the mounting structure in which the air layer 8 is disposed in between the substrate 3 and the touch panel, light reflection and refraction occur in the interface and some light scattering is generated, which causes slightly scattered light to enter the diffusion adhesive layer 22 to enhance the diffusion effect. Therefore, in order to prevent images from being whitened, the haze value of the diffusion adhesive layer 22 is set at 5 to 45% since slightly smaller haze value is more beneficial. More preferable haze of the diffusion adhesive layer 22 is 25 to 35%. Moreover, the thickness of the diffusion adhesive layer 22 needs to be at least 10 μm so as to obtain adhesive strength.

Although description above has been given of the second embodiment of the present invention, the present invention is not limited thereto.

For example, as the third embodiment of the present invention, it is possible to provide a diffusion function to the support plate 29 instead of providing the diffusion function to the diffusion adhesive layer 22. More particularly, a transparent support plate (hereinbelow referred to as a diffusion support plate 24) which is made of a plastic plate having diffusivity, functions as a reinforcement of the lower insulating substrate 6 so as to withstand pressure application to the touch panel during input operation, and which constitutes a part of a fourth example of the diffusion bonding member is structured to be entirely bonded to the back surface of the lower insulating substrate 6 by an adhesive layer 21 constituting a part of the fourth example of the diffusion bonding member (see FIG. 23).

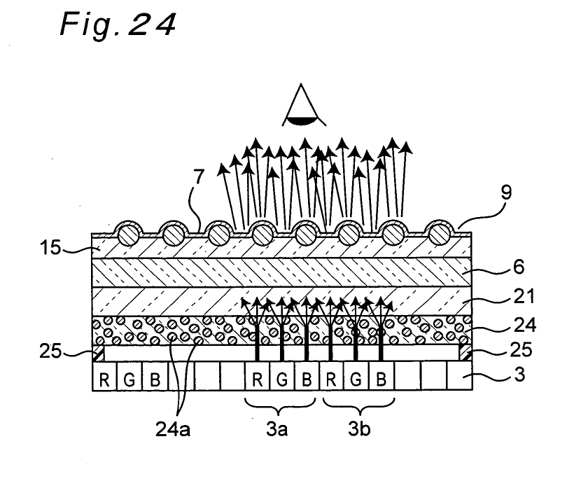

The diffusion support plate 24 is composed of a plastic plate made of PC (polycarbonate), PMMA (methacrylate), MS (methyl methacrylate-styrene copolymer), or epoxy, and fillers 24a dispersed as light diffusing agents in the plastic plate, and visible light from the display 3 is refracted and reflected by the fillers 24a. More particularly, the visible light from the display 3 is scattered in advance in multi-directions by the fillers 24a before the light reaches the lower insulating substrate 6 (see FIG. 24), and therefore the light having the color of the same wavelength which passed through the same point on the satin finished surface 9 has multiple traveling directions. Eventually, as with the second embodiment, significant difference no longer exists no matter at which point of the satin finished surface 9 the light is refracted, and therefore, in the case where, for example, RGB light emission is conducted such that totally identical additive color mixture is applied to a certain pixel 3a and an adjacent pixel 3b on the screen of the display 3, displayed colors of the pixel 3a and the pixel 3b recognized by a viewer at the final stage are no longer different. As a result, even if the display is high definition, the screen does not look like glaring.

As the adhesive layer 21, there may be used, as with the prior art, an acrylic transparent adhesive such as acrylic ester. The constitution other than that of the diffusion support plate 24 and the adhesive layer 21 is as described before.

Moreover, the level of dispersion of the fillers in the diffusion support plate 24 in the third embodiment may also be expressed by the haze (haze value) of the diffusion support plate 24 itself which is obtained by JIS K 7105 (1981), and the haze of the diffusion support plate 24 is adjusted to be 10 to 50% because of the same reason as with the case of the diffusion adhesive layer 10. More preferably, the haze of the diffusion support plate 24 is 25 to 35%.

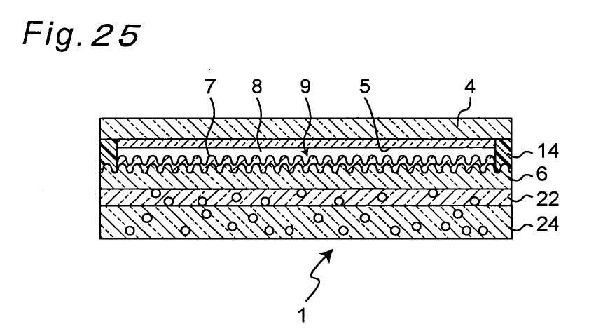

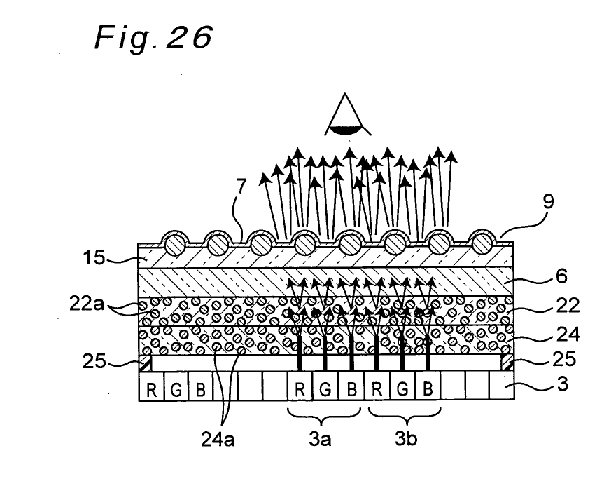

Further, as the fourth embodiment of the present invention, the second and third embodiments may be combined to provide the diffusion function to both the adhesive layer and the support plate. More particularly, as a fifth example of the diffusion bonding member, the diffusion support plate 24 is structured to be entirely bonded to the back surface of the lower insulating substrate 6 by the diffusion adhesive layer 22 (see FIG. 25). Visible light from the display 3 is scattered in advance in multi-directions by the diffusion adhesive layer 22 and the diffusion support plate 24 before the light reaches the lower insulating substrate 6 (see FIG. 26), and therefore even the light having the color of the same wavelength which passed through the same point on the satin finished surface 9 has multiple traveling directions. Therefore, the same effects as those in the second and third embodiments may be achieved. It is to be noted that the level of dispersion of the fillers 24a in the diffusion adhesive layer 22 and the diffusion support plate 24 in the fourth embodiment is adjusted such that the haze of the diffusion support plate 24 with the diffusion adhesive layer 22 provided on its top surface is 10 to 50%. If the haze of the diffusion support plate 24 is less than 10%, it becomes difficult to suppress interference between the satin finishing treatment of the touch panel and pixels of the display 3. If the haze of the diffusion support plate 24 is beyond 50%, the diffusion support plate itself is whitened and visibility of the display 3 is degraded. More preferably, the haze of the diffusion support plate 24 is 25 to 35%.

Following description discusses the comparison between working examples 4 to 6 of the second to fourth embodiments of the present invention and comparative examples 2 and 3.

### WORKING EXAMPLE 4

A PC film with a thickness of 100 μm was used as the lower insulating substrate, its upper surface was mat-coated by a roll coater with a 5 μm-thick acrylic resin in which SiO₂ particles with a particle size of 2 μm are dispersed as light diffusing agents, and was subjected to satin finishing treatment to form a satin finished surface having surface haze of 3%, and a lower electrode made of a 20 nm-thick ITO film was formed on the satin finished surface by sputtering to form a lower electrode plate. Further, a 0.5 mm-thick PC plate was used as the support plate, its upper surface was coated by screen printing with an ink composed of an adhesive layer made of acrylic ester in which SiO₂ particles with a particle size of 1 μm were dispersed as light diffusing agents, and after a diffusion adhesive layer with a thickness of 20 μm and haze of 15% was formed on the entire surface, the plate was stuck to the back surface of the lower insulating substrate of the lower electrode plate to form a lower electrode plate with a support plate.

A 188 μm-thick PET film was used as the upper insulating substrate, its lower surface was coated with a 5 μm-thick acrylic resin by a roll coater, an upper electrode made of a 20 nm-thick ITO film was formed on the coating layer by sputtering, and the surface of the upper insulating substrate opposite to the surface on which the upper electrode was formed was coated with 5 μm-thick acrylic resin by a roll coater to form the upper electrode plate.

After circuits with specified patterns were formed on the above-stated upper electrode plate and the lower electrode plate with the support plate by screen printing, the upper electrode plate and the lower electrode plate with the support plate were disposed so as to face each other with an air layer interposed in between the electrodes, and both the plates were bonded at a periphery portion with a double-faced adhesive tape to obtain a touch panel which prevents Newton rings from being generated between both the electrodes.

### WORKING EXAMPLE 5

The constructions similar to those in the working example 4 were provided except that a 0.5 mm-thick PC plate in which SiO₂ particles with a particle size of 1 μm were dispersed as light diffusing agents to have haze of 15% was used as the diffusion support plate, its upper surface was coated with a transparent adhesive made of acrylic ester by screen printing, and after a diffusion adhesive layer with a thickness of 20 μm was formed on the entire surface, the plate was stuck to the back surface of the lower insulating substrate of the lower electrode plate to form a lower electrode plate with a support plate.

### WORKING EXAMPLE 6

The constructions similar to those in the working example 4 were provided except that a 0.5 mm-thick PC plate in which SiO₂ particles with a particle size of 1 μm were dispersed as light diffusing agents was used as the diffusion support plate, its upper surface was coated by screen printing with an ink composed of an adhesive layer made of acrylic ester in which SiO₂ particles with a particle size of 1 μm were dispersed as light diffusing agents, and after a diffusion adhesive layer with a thickness of 20 μm was formed on the entire surface so as to set the haze of the diffusion support plate with the diffusion adhesive layer provided on its surface at 15%, the plate was stuck to the back surface of the lower insulating substrate of the lower electrode plate to form a lower electrode plate with a support plate.

### COMPARATIVE EXAMPLE 2

The constructions similar to those in the working example 4 were provided except that the lower insulating substrate of the lower electrode plate was stuck to the support plate by a 20 μm-thick adhesive layer made of acrylic ester.

### COMPARATIVE EXAMPLE 3

The constructions similar to those in the working example 4 were provided except that the lower insulating substrate of the lower electrode plate was stuck to the support plate by a 20 μm-thick adhesive layer made of acrylic ester, and further, the satin finishing treatment was not applied to the lower insulating substrate.

When the touch panels in the working examples 4 to 6 and the comparative examples 2 and 3 were disposed on the front surface of a high-definition color LCD and visibility of LCD display was observed, glare was not seen in the working example 4, and its display bore comparison with the display by an LCD as a single unit. However, in the comparative example 2, glare occurred and thereby visibility was degraded. In the comparative example 3, though the glare did not occur, Newton rings were generated and thereby visibility was also degraded.

The touch panel with the support plate of the present invention is constituted as described above and therefore the following effects are achieved.

That is, the touch panel with the support plate of the present invention is composed of the touch panel having the satin finished surface formed on at least either facing surface of the upper insulating substrate and the lower insulating substrate, in which the support plate made of the plastic plate as an example of the diffusion bonding member is entirely bonded to the back surface of the lower insulating substrate by the adhesive layer, and either the support plate or the adhesive layer has the diffusion function to refract and reflect visible light from the display, so that by the diffusion function of the support plate or the adhesive layer as an example of the diffusion bonding member, visible light from the display is scattered in advance in multi-directions before the light reaches the lower insulating substrate.

Further, the touch panel with the support plate of the present invention is composed of the touch panel having the satin finished surface formed on at least either facing surface of the upper insulating substrate and the lower insulating substrate, in which the diffusion support plate made of the plastic plate as an example of the diffusion bonding member is entirely bonded to the back surface of the lower insulating substrate by the diffusion adhesive layer, so that by the diffusion support plate and the fillers in the diffusion adhesive layer, visible light from the display is scattered in advance in multi-directions before the light reaches the lower insulating substrate.

As a result, in either case, there is no longer significant difference in the traveling direction of light no matter at which point of the satin finished surface the light is refracted, and therefore, in the case where, for example, RGB light emission is conducted such that totally identical additive color mixture is applied to a certain pixel and an adjacent pixel on the screen of the display, displayed colors of both the pixels recognized by a viewer at the final stage are no longer different. Therefore, even if the display is high definition, the screen does not look like glaring.

It is to be understood that among the aforementioned various embodiments, arbitrary embodiments may be properly combined so as to achieve the effects possessed by each embodiment.

Although the present invention has been fully described in connection with the preferred embodiments thereof with reference to the accompanying drawings, it is to be noted that various changes and modifications are apparent to those skilled in the art. Such changes and modifications are to be understood as included within the scope of the present invention as defined by the appended claims unless they depart therefrom.

1-14. (canceled)

15. A mounting structure for a touch panel, comprising a touch panel which is composed of an upper electrode plate having an upper electrode made of transparent conductive film formed on a lower surface of an upper insulating substrate made of plastic film, and a lower electrode plate having a lower electrode made of transparent conductive film formed on an upper surface of a lower insulating substrate made of plastic film, said upper electrode plate and said lower electrode plate being disposed so as to face each other with an air layer interposed in between said upper and lower electrodes, and which has a satin finished surface formed on at least either facing surface of said upper insulating substrate and said lower insulating substrate,
wherein by a diffusion bonding member for refracting and reflecting visible light from a display, said touch panel is bonded to said display for mounting of said touch panel thereto, said diffusion bonding member is a diffusion adhesive layer for bonding said touch panel and said display entirely, haze of said diffusion adhesive layer is 10 to 50%, and surface haze of said satin finished surface of said touch panel is 1.5 to 5%.

16. The mounting structure for a touch panel as defined in claim 15, wherein said diffusion bonding member is a transparent mounting sheet formed from said diffusion adhesive layer laid on one surface of a silicon rubber sheet, and
a front surface of said display is entirely bonded to said diffusion adhesive layer of said mounting sheet, and said touch panel is mounted on a front surface of said mounting sheet placed on said display so as to bring said silicon rubber sheet of said mounting sheet into contact with said touch panel.

17. The mounting structure for a touch panel as defined in claim 15, wherein said diffusion bonding member is a transparent mounting sheet formed from said diffusion adhesive layer laid on one surface of a silicon rubber sheet,
a back surface of said touch panel is entirely bonded to said mounting sheet by said diffusion adhesive layer of said mounting sheet, and said touch panel with said mounting sheet provided is mounted on a front surface of said display so as to bring said silicon rubber sheet of said mounting sheet into contact with said display.

18. The mounting structure for a touch panel, comprising a touch panel which is composed of an upper electrode plate having an upper electrode made of transparent conductive film formed on a lower surface of an upper insulating substrate made of plastic film, and a lower electrode plate having a lower electrode made of transparent conductive film formed on an upper surface of a lower insulating substrate made of plastic film, said upper electrode plate and said lower electrode plate being disposed so as to face each other with an air layer interposed in between said upper and lower electrodes, and which has a satin finished surface formed on at least either facing surface of said upper insulating substrate and said lower insulating substrate,
wherein by a diffusion bonding member for refracting and reflecting visible light from a display, said touch panel is bonded to said display for mounting of said touch panel thereto, said diffusion bonding member is composed of an adhesive layer disposed on a back surface of said lower insulating substrate and a support plate made of a plastic plate which is bonded entirely to said back surface of said lower insulating substrate by said adhesive layer, said adhesive layer has a diffusion function to refract and reflect visible light from said display, haze of said adhesive layer is 5 to 45%, and surface haze of said satin finished surface of said touch panel is 1.5 to 5%.

19. The mounting structure for a touch panel as defined in claim 18, wherein the diffusion function is to refract and reflect visible light from said display with fillers which are dispersed as light diffusing agents.

20. The mounting structure for a touch panel as defined in claim 18, wherein said diffusion bonding member is further composed of an adhesive layer for entirely bonding said touch panel and said display.

21. A touch panel with a support plate for use in the mounting structure for a touch panel as defined in claim 18.

22. A mounting structure for a touch panel, comprising a touch panel which is composed of an upper electrode plate having an upper electrode made of transparent conductive film formed on a lower surface of an upper insulating substrate made of plastic film, and a lower electrode plate having a lower electrode made of transparent conductive film formed on an upper surface of a lower insulating substrate made of plastic film, said upper electrode plate and said lower electrode plate being disposed so as to face each other with an air layer interposed in between said upper and lower electrodes, and which has a satin finished surface formed on at least either facing surface of said upper insulating substrate and said lower insulating substrate, wherein by diffusion bonding member for refracting and reflecting visible light from a display, said touch panel is bonded to said display for mounting of said touch panel thereto, said diffusion bonding member is composed of an adhesive layer disposed on a back surface of said lower insulating substrate and a support plate made of a plastic plate which is bonded entirely to said back surface of said lower insulating substrate by said adhesive layer, said support plate has a diffusion function to refract and reflect visible light from said display haze of said support plate is 10 to 50%, and surface haze of said satin finished surface of said touch panel is 1.5 to 5%.

23. The mounting structure for a touch panel as defined in claim 22, wherein the diffusion function is to refract and reflect visible light from said display with fillers which are dispersed as light diffusing agents.

24. The mounting structure for a touch panel as defined in claim 22, wherein said diffusion bonding member is further composed of an adhesive layer for entirely bonding said touch panel and said display.

25. A touch panel with a support plate for use in the mounting structure for a touch panel as defined in claim 22.
